(19) United States
(12) Patent Application Publication
(10) Pub. No.: US 2009/0269444 A1
(43) Pub. Date: Oct. 29, 2009

(54) FLEXIBLE PACKAGE WITH SHELF-LIFE INDICATING CARD WINDOW AND METHOD OF PACKAGING A PRODUCT IN A FLEXIBLE PACKAGE

(75) Inventor: John S. Thomas, JR., Coopersburg, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: FRES-CO SYSTEM USA, INC., Telford, PA (US)

(21) Appl. No.: 12/426,427

(22) Filed: Apr. 20, 2009

Related U.S. Application Data
(60) Provisional application No. 61/048,378, filed on Apr. 28, 2008.

(51) Int. Cl. G09F 3/18

(52) U.S. Cl. 426/87; 426/383

(57) ABSTRACT

A flexible package and a method of packaging a product having a distinct shelf life in a flexible package to provide an indication of the product's shelf-life. The package has a hollow body formed of a flexible material in which the product is disposed and which is suitable for isolating the product within the package from the ambient atmosphere. The body also includes a window portion formed of a transparent material and an internal pocket located under the window. The internal pocket is arranged to hold a shelf-life indicating card at the window to be visible therethrough. The card may include indicia which is changeable in response to conditions existing within the package.

### CROSS-REFERENCE TO RELATED APPLICATIONS

This application claims priority from Provisional Application Ser. No. 61/048,378, filed on Apr. 28, 2008, entitled Flexible Package With Shelf-Life Indicating Card Window, which application is assigned to the same assignee as this application and whose disclosure is incorporated by reference herein.

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISK

“Not Applicable”

### FIELD OF THE INVENTION

This invention relates generally to flexible packages and more particularly to packages for holding products having a defined shelf-life, wherein the package includes a section arranged to hold a card or other indicia bearing member indicating the shelf-life of the product enclosed and a method of packaging such a product in a flexible package.

### BACKGROUND OF THE INVENTION

Some products that are provided in flexible packages include some means to automatically provide an indication of the product's shelf-life. One such means is sometimes referred to as a “fit-for-use” card and may comprise an indicating dot or some other indicia on a card that changes color when a condition within the package is reached, e.g., the moisture content inside the package exceeds the design criteria of the product contained within the package. Typically such fit-for-use cards are disposed within the package to be visible through the package (e.g., the package can be formed of a transparent film in single or multiple plies) or may have a transparent window portion).

For applications where the product to be contained within the flexible package is highly hygroscopic, e.g., it comprises a moisture desiccant material that is packed into small “breathable” sachets and is used in molecular sieve's to create zero moisture atmosphere., a relatively long shelf life package is desirable. For example, some hygroscopic products, such as those desiccant materials, can only tolerate a very low moisture gain, e.g., 0.2% moisture gain. Any moisture gain beyond that level and the product becomes un-useable. Current packaging provides only three months shelf life using PCTFE (e.g., ACLAR® film available from Honeywell International, Inc.). That material is clear and is a very good barrier. It is also resistant to flexure cracking. Moreover, the clarity of the PCTFE allows one to insert a “fit for use” card bearing indicia showing the shelf-life of the product and to have that card visible through the package. However, as is known PCTFE is rather expensive (e.g., $18 to $40 per pound). Thus, making the entire package of such material is not economic in order to enable the user to readily see the fit-for-use card. Moreover, the fit-for-use card may become displaced or otherwise buried in the contents of the package, so that it is not visible irrespective of whether or not the entire package is made of the transparent material like the ACLAR® film.

As is known other materials flexible packaging materials are available and are less expensive than the ACLAR® film and which can provide enhanced moisture penetration resistance, e.g., ALU foil which has zero effective permeability. However, such materials are not sufficiently transparent to enable a fit-for-use card to be visible therethrough.

Thus, a need presently exists for a package that provides excellent moisture barrier resistance to provide increased shelf life for a product to be held therein, with means for holding a shelf-life indicating card or some other “fit-for-use” bearing item within the package readily visible at all times.

The subject invention addresses that need.

All references cited herein are incorporated herein by reference in their entireties.

### SUMMARY OF THE INVENTION

In accordance with one aspect of this invention there is provided a flexible package for holding a product therein, the product having a shelf life dependent upon conditions within the package. The package comprises a hollow body formed of a flexible material in which the product is arranged to be disposed. The flexible material is selected to be suitable for isolating the product within the package from the ambient atmosphere. The body includes a window portion formed of a transparent material and an internal pocket located adjacent the window. The internal pocket is arranged to hold a member, e.g., a card, including indicia (e.g., a dot which changes color in response to conditions within the package, providing an indication of the product's shelf-life so that it is visible through said window.

In accordance with another aspect of this invention there is provided a method of packaging a product in a flexible package to provide an indication of the product's shelf-life, with the product having a shelf life dependent upon conditions within the package. The method basically entails providing a package comprising a hollow body formed of a flexible material having an interior in which the product is arranged to be disposed, the flexible material being suitable for isolating the product within the package from the ambient atmosphere, and with the body including a window portion formed of a transparent material and an internal pocket located adjacent the window. An indicating member, e.g., a card including indicia automatically changing color in response to conditions within the package, is disposed in the internal pocket so that the indicating member is visible through the window.

### DESCRIPTION OF THE DRAWING

FIG. 1 is a front elevational view showing one exemplary package constructed in accordance with this invention;

FIG. 2 is a sectional view taken along line 2-2 of FIG. 1, but with the contents of the package not being shown in the interest of drawing simplicity;

FIG. 3 is an enlarged sectional view of the portion of the package of FIG. 1 shown within the circular area designated by the reference number 3 in that figure; and

FIG. 4 is an enlarged sectional view, like that of FIG. 3, but showing an alternative exemplary embodiment of this invention.

### DETAILED DESCRIPTION OF THE PREFERRED EMBODIMENT

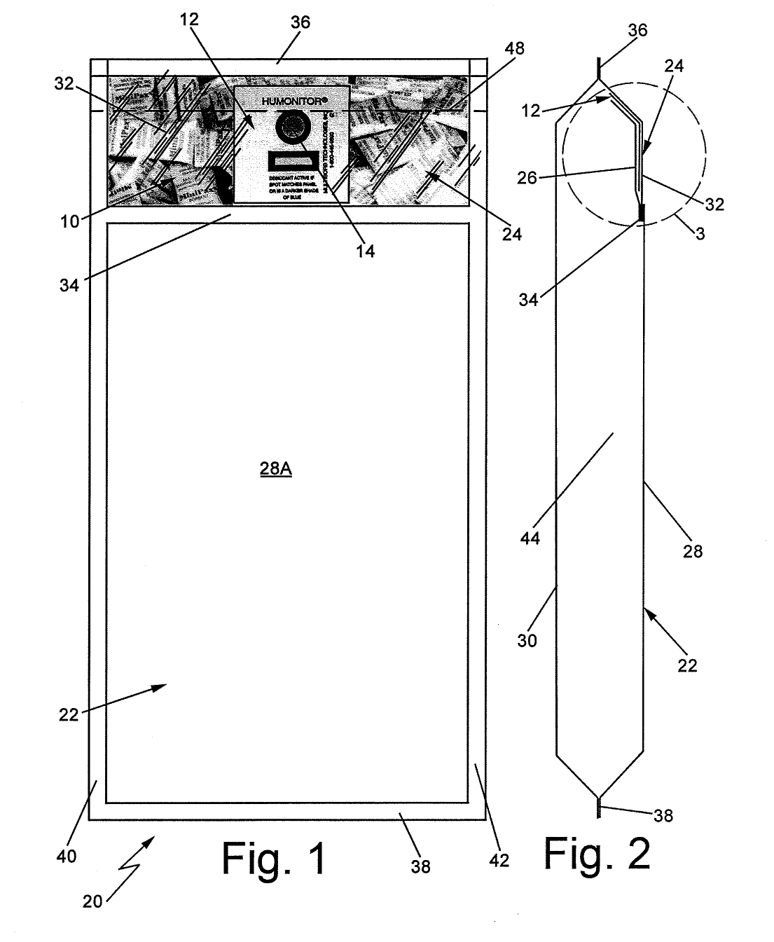

Referring now to the various figures of the drawing wherein like reference characters refer to like parts, there is shown at 20 in FIG. 1 one exemplary embodiment of a flexible package constructed in accordance with this invention for holding some product 10 therein and providing a window through which a shelf-life indication (e.g., fit-for-use) card 12 is visible. That card is in communication with the interior of the package in which the product is located so that it can automatically provide an indication of the shelf-life of the product based on the conditions within the package. In the exemplary embodiment shown wherein the package 20 is arranged to hold a hygroscopic material, such as a moisture desiccant material that is packed into a plurality of small “breathable” sachets 10, the card 12 include a dot 14 or some other indicia which is arranged to change color when the moisture content in the package reaches a predetermined level.

The package 20 is in the form of a pillow-like pouch, but could be of other configurations, e.g., a gusseted package, if desired. The pouch 20 basically comprises a body portion 22, a transparent window portion 24 and an interior pocket 26 arranged to hold the shelf-life indication card 12 within the pouch to be visible through the window portion. The pouch's body portion is formed of any suitable material for isolating the contents of the pouch from the ambient atmosphere. Where the product held within the package is a highly moisture sensitive material, such as the sachets 10, the material making up the body portion is any flexible material having a very low moisture permeability. That material can be in the form of a single ply or multiple plies, e.g., laminates, co-extrusions, etc. ALU foil is particularly suitable since it has zero effective permeability.

The pouch's body portion includes a front panel 28 and a rear panel 30 (FIG. 2). The front panel 28 includes two portions, namely, an upper portion that forms the heretofore identified window portion 24 and a main or lower portion 28A. The entire rear panel 30 and the lower portion 28A of the front panel 28 are formed of respective sheets of ALU foil. The upper edge of the ALU sheet making up the main portion 28A of the front panel is fixedly secured to the lower edge of a sheet of transparent flexible film 32 of the same width as the lower portion 28A by a seal line 34 (FIGS. 1, 3 and 4). The sheet 32 forms the heretofore identified window portion 24 of the package. In order to ensure that the package 20 provides good protection from the ingress of moisture into it, the transparent film is selected to exhibits relatively low moisture permeability. For example, it may be formed of LLDPE/SiOx Coated PET/LLDPE. The sheet 32 is of a height and width so that when it is secured to the lower portion 28A the resulting front panel 28 is coextensive in size and shape to the rear panel 30 of the package 20. The top edge of the front and rear panels are sealed together by a peripheral seal line 36. The bottom edge of the front and rear panels are sealed together by a peripheral seal line 38 and the side edges of those panels are also sealed together by peripheral seal lines 40 and 42. Accordingly, when the front and rear panels are secured to each other by those seal lines a hollow interior 44 is provided within the package. It is in this hollow interior that the product 10, e.g., the sachets, is located although those sachets are not shown in FIG. 2 in the interests of drawing simplicity. However, as shown clearly in FIG. 1 a portion of those sachets are visible through the window portion 24.

The card holding interior pocket 26 is located within the hollow interior 44 of the package 20 directly under the window portion 24 so that the shelf-life indicating card 12 can be held there and still in communication with the interior of the pouch. When so located the card 12 with the shelf-life bearing indicia (e.g., color-changing dot) 14 faces outward, to be readily viewable through the transparent window.

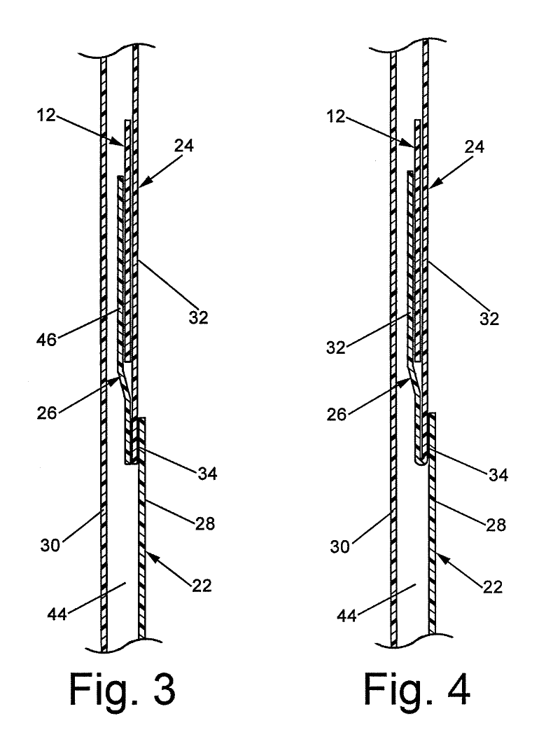

In FIG. 3 there is shown one embodiment of the window portion and the underlying interior pocket constructed in accordance with this invention. In particular, in that embodiment the interior pocket 26 is made up of a relatively small panel 46 of a flexible film that is fixedly secured, e.g., sealed, along its lower edge to the underside of the window-forming film 32. The small panel 46 can be the same material as the window portion or any other transparent material, if it is desired that the contents of the package also be visible through the window along with the shelf-life indicating card 12 (as is the preferred embodiment disclosed herein). Moreover, in the embodiment shown in FIG. 3 the line at which the pocket forming separate sheet 46 is secured to the front panel 28 is along the transverse seal line 34.

In FIG. 4 there is shown an alternative embodiment of the package of this invention. That package is identical in construction to the package described with respect to FIGS. 1-3, except for the fact that the window portion 24 and the interior pocket 26 are formed of a common (single) sheet 32 that is folded along a bottom fold line 50 and is sealed at that fold line to the underside of the lower portion 28A of the front panel 28 via the heretofore identified transverse seal line 34.

As best seen in FIG. 1 the package includes a tear or cut line 48 (shown by the broken line in FIG. 1) along which the package can be cut or torn open to provide access to the contents 10 of the package.

The following constitutes a set of exemplary specifications for a commercial product constructed in accordance with this invention for holding plural sachets 10 and a shelf-life indicating card.
Pouch Size=0.2286 m×0.483 m=0.11 m2
Pouch made from ALU has zero effective permeability.
Pouch window has some permeability.
Pouch Window Size=0.230 m×0.095 m=0.022 m2
Clear Barrier Material: LLDPE/SiOx Coated PET/LLDPE
Moisture Transmission Rate=0.7 g/m2/day
Moisture Transmission Rate of Pouch=0.7 g/m2/day×0.022 m2=0.0154 g/day
Product Shelf Life=4.54 g/0.0154 g/day=294 days

As will be appreciated by those skilled in the art, the subject package offers a distinct advantage over the prior art since it enables most of the package to be made of a better barrier material, e.g., foil, (to extend its shelf life), while still ensuring that a fit-for-use card located within the package will be visible at all times to give an indication of the product's shelf life.

Without further elaboration the foregoing will so fully illustrate my invention that others may, by applying current or future knowledge, adopt the same for use under various conditions of service.

I claim:

1. A flexible package for holding a product therein, the product having a shelf life dependent upon conditions within the package, said package comprising a hollow body formed of a flexible material in which the product is arranged to be disposed, said flexible material being suitable for isolating the product within said package from the ambient atmosphere, said body including a window portion formed of a transparent material and an internal pocket located adjacent said window, said internal pocket being arranged to hold a member including indicia providing an indication of the product's shelf-life so that it is visible through said window.

2. The flexible package of claim 1 wherein the flexible material of the body comprises ALU foil.

3. The flexible package of claim 1 wherein said window portion comprises LLDPE/SiOx Coated PET/LLDPE.

4. The flexible package of claim 2 wherein said window portion comprises LLDPE/SiOx Coated PET/LLDPE.

5. In combination a flexible package for holding a product and an indicating member including indicia providing an indication of the product's shelf-life, the product having a shelf life dependent upon conditions within the package, said package comprising a hollow body formed of a flexible material in which the product is arranged to be disposed, said flexible material being suitable for isolating the product within said package from the ambient atmosphere, said body including a window portion formed of a transparent material and an internal pocket located adjacent said window, said internal pocket being arranged to hold said indicating member so that it is visible through said window.

6. The combination of claim 5 wherein said flexible material of the body comprises ALU foil.

7. The combination of claim 5 wherein said window portion comprises LLDPE/SiOx Coated PET/LLDPE.

8. The combination of claim 6 wherein said window portion comprises LLDPE/SiOx Coated PET/LLDPE.

9. The combination of claim 1 wherein said indicating member comprises a card.

10. The combination of claim 9 wherein said card includes indicia automatically changing in response to conditions within said package.

11. The combination of claim 10 wherein said indicia changes color in response to conditions within said package.

12. The combination of claim 11 wherein said indicia changes color in response to the moisture content within said package.

13. A method of packaging a product in a flexible package to provide an indication of the product's shelf-life, the product having a shelf life dependent upon conditions within the package, said method comprising:
providing a package comprising a hollow body formed of a flexible material having an interior in which the product is arranged to be disposed, said flexible material being suitable for isolating the product within said package from the ambient atmosphere, said body including a window portion formed of a transparent material and an internal pocket located adjacent said window; and
disposing an indicating member in said internal pocket so that said indicating member is visible through said window.

14. The method of claim 13 wherein said indicating member is disposed in said internal pocket and in communication with said interior of said hollow body.

15. The method of claim 14 wherein said indicating member comprises a card.

16. The method of claim 15 wherein said card includes indicia automatically changing in response to conditions within said package.

17. The method of claim 16 wherein said indicia changes color in response to conditions within said package.
